(19) United States
(12) Patent Application Publication
(10) Pub. No.: US 2025/0069438 A1
(43) Pub. Date: Feb. 27, 2025

(54) FACIAL MICRO-EXPRESSION RECOGNITION SYSTEMS AND METHODS

(71) Applicant: Board of Trustees of the University of Arkansas, Little Rock, AR (US)

(72) Inventors: Khoa Luu, Fayetteville, AR (US); Xuan Bac Nguyen, Fayetteville, AR (US)

(73) Assignee: Board of Trustees of the University of Arkansas, Little Rock, AR (US)

(21) Appl. No.: 18/809,182

(22) Filed: Aug. 19, 2024

Related U.S. Application Data
(60) Provisional application No. 63/533,165, filed on Aug. 17, 2023.

(51) Int. Cl. G06V 40/16; G06V 10/25; G06V 10/82

(52) U.S. Cl. CPC G06V 40/176; G06V 10/25; G06V 10/82; G06V 2201/03

(57) ABSTRACT

Embodiments pertain to a computer-implemented method of identifying at least one facial micro-expression pattern of a face of a subject by (1) receiving a plurality of images of the face of the subject, where the plurality of images represent consecutive images of the face of the subject taken sequentially during a period of time; (2) feeding the plurality of images into a machine-learning algorithm, where the machine-learning algorithm includes a diagonal micro attention (DMA) module that identifies at least one facial micro-movement between the plurality of images and correlates the facial micro-movement to at least one facial micro-expression pattern; and (3) outputting the facial micro-expression pattern of the face of the subject. Additional embodiments pertain to computing devices for identifying at least one facial micro-expression pattern of a face of a subject in accordance with the aforementioned processes.

### CROSS-REFERENCE TO RELATED APPLICATIONS

This application claims priority to U.S. Provisional Patent Application No. 63/533,165, filed on Aug. 17, 2023. The entirety of the aforementioned application is incorporated herein by reference.

### BACKGROUND

Current systems and methods for identifying facial micro-expression patterns have numerous limitations. Numerous embodiments of the present disclosure aim to address the aforementioned limitations.

### SUMMARY

In some embodiments, the present disclosure pertains to a computer-implemented method of identifying at least one facial micro-expression pattern of a face of a subject. In some embodiments, the methods of the present disclosure include: (1) receiving a plurality of images of the face of the subject, where the plurality of images represent consecutive images of the face of the subject taken sequentially during a period of time; (2) feeding the plurality of images into a machine-learning algorithm, where the machine-learning algorithm includes a diagonal micro attention (DMA) module that identifies at least one facial micro-movement between the plurality of images and correlates the facial micro-movement to at least one facial micro-expression pattern; and (3) outputting the facial micro-expression pattern of the face of the subject.

In some embodiments, the methods of the present disclosure also include a step of making a determination based on the identified facial micro-expression pattern. In some embodiments, the determination includes lie detection. In some embodiments, the determination includes diagnosis of a disease or condition. In some embodiments, the methods of the present disclosure also include a step of implementing a treatment regimen for the disease or condition.

Additional embodiments of the present disclosure pertain to computing devices for identifying at least one facial micro-expression pattern of a face of a subject. In some embodiments, the computing device includes one or more computer readable storage mediums having a program code embodied therewith. In some embodiments, the program code includes programming instructions for: (1) receiving a plurality of images of the face of the subject, where the plurality of images represent consecutive images of the face of the subject taken sequentially during a period of time; (2) feeding the plurality of images into a machine-learning algorithm, where the machine-learning algorithm includes a DMA module that identifies at least one facial micro-movement between the plurality of images and correlates the facial micro-movement to at least one facial micro-expression pattern; and (3) outputting the facial micro-expression pattern of the face of the subject. In some embodiments, the computing devices of the present disclosure also include a display for displaying a facial micro-expression pattern of the face of the subject.

### BRIEF DESCRIPTION OF THE DRAWINGS

A better understanding of the present invention can be obtained when the following detailed description is considered in conjunction with the following drawings, in which:

FIG. 1 provides a block diagram of a computer-implemented method of identifying at least one facial micro-expression pattern of a face of a subject.

FIG. 2 provides an illustration of a system of identifying at least one facial micro-expression pattern of a face of a subject.

FIG. 3 provides an illustration of a computer-implemented method of identifying at least one facial micro-expression pattern of a face of a subject. In particular, FIG. 3 provides an overview of a μ-BERT approach to facial micro-expression recognition, as described in Example 1.

FIG. 4 illustrates that, given two frames from a high-speed video, the proposed μ-BERT method can localize and highlight the regions of micromovements.

FIG. 5 shows building blocks of Encoder and Decoder. Each block includes Multi-Head Attention (MHA) and Layer Normalization.

FIG. 6 shows blockwise swapping. For each triplet, Applicant presents the Iₜ (left), the I_{t+δ} (middle) and the I_{t/s} (right). The yellow blocks in Its represent swapped patches from I_{t+δ} that are randomly swapped into Iₜ.

FIG. 7 shows a diagonal micro-Attention (DMA) module. Diagonal values from the attention map between P_{t/s} and P_{t+δ} are used to rank the importance of each patch in the swapped image.

FIG. 8 shows a Patch of Interest (POI) module. The Pₜ and P_{t+δ/c} are sequence of patch features of I_{t+δ} and its random cropped version. p^{CT}_{t+δ} and p^{CT}_{t+δ/c} are their corresponding contextual features.

FIG. 9 shows the demonstration of how μ-BERT perceives the tiny differences between two frames. The first two rows are onset and apex input frames. The third and fourth rows are the results of RAFT and MagNet, respectively. The rest of the rows are Applicant's μ-BERT results.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Facial expressions are a complex mixture of conscious reactions directed toward given stimuli. They involve experiential, behavioral, and physiological elements. Because they are crucial to understanding human reactions, this topic has been widely studied in various application domains.

In general, facial expression problems can be classified into two main categories, macro-expression and micro-expression. The main differences between the two are pixel intensity and duration. In particular, macro-expressions happen spontaneously, cover large movement areas in a given face (e.g., mouth, eyes, checks), and typically last from 0.5 to 4 seconds.

Humans can usually recognize these expressions. By contrast, micro-expressions are involuntary occurrences, have low intensity, and last between 5 milliseconds and half a second.

Indeed, micro-expressions are challenging to identify and are mostly detectable only by experts. Micro-expression understanding is essential in numerous applications, such as lie detection, which is crucial in criminal analysis.

Micro-expression identification requires both semantics and micro-movement analysis. Since they are difficult to observe through human eyes, a high-speed camera, usually with 200 frames per second (FPS), is typically used to capture the required video frames. Previous work tried to understand this micro information using MagNet to amplify small motions between two frames (e.g., onset and apex frames). However, these methods still have limitations in terms of accuracy and robustness.

In sum, current systems and methods for identifying facial micro-expression patterns have numerous limitations. Numerous embodiments of the present disclosure aim to address the aforementioned limitations.

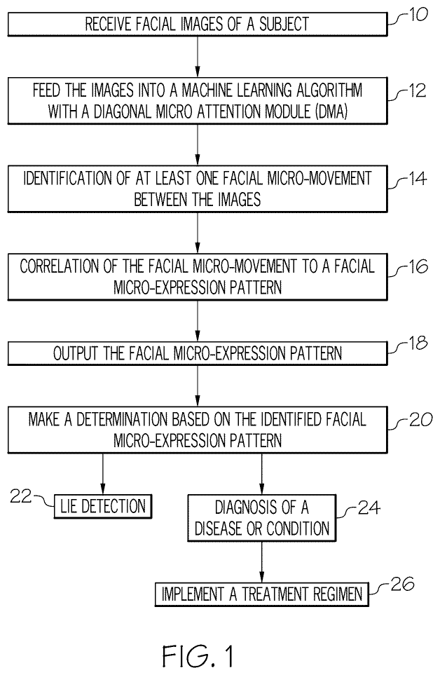

In some embodiments, the present disclosure pertains to a computer-implemented method of identifying at least one facial micro-expression pattern of a face of a subject. In some embodiments illustrated in FIG. 1, the methods of the present disclosure include: receiving a plurality of images of the face of the subject, where the plurality of images represent consecutive images of the face of the subject taken sequentially during a period of time (step 10); feeding the plurality of images into a machine-learning algorithm, where the machine-learning algorithm includes a diagonal micro attention (DMA) module that identifies at least one facial micro-movement between the plurality of images and correlates the facial micro-movement to at least one facial micro-expression pattern (steps 12, 14, and 16); and outputting the facial micro-expression pattern of the face of the subject (step 18).

In some embodiments, the methods of the present disclosure also include a step of making a determination based on the identified facial micro-expression pattern (step 20). In some embodiments, the determination includes lie detection (step 22). In some embodiments, the determination includes diagnosis of a disease or condition (step 24). In some embodiments, the methods of the present disclosure also include a step of implementing a treatment regimen for the disease or condition (step 26).

Additional embodiments of the present disclosure pertain to computing devices for identifying at least one facial micro-expression pattern of a face of a subject. In some embodiments, the computing device includes one or more computer readable storage mediums having a program code embodied therewith. In some embodiments, the program code includes programming instructions for: (1) receiving a plurality of images of the face of the subject, where the plurality of images represent consecutive images of the face of the subject taken sequentially during a period of time; (2) feeding the plurality of images into a machine-learning algorithm, where the machine-learning algorithm includes a DMA module that identifies at least one facial micro-movement between the plurality of images and correlates the facial micro-movement to at least one facial micro-expression pattern; and (3) outputting the facial micro-expression pattern of the face of the subject. In some embodiments, the computing devices of the present disclosure also include a display for displaying a facial micro-expression pattern of the face of the subject.

As set forth in more detail herein, the methods and computing devices of the present disclosure can have numerous embodiments.

### Images

The methods and computing devices of the present disclosure may receive or capture various types of images. For instance, in some embodiments, the plurality of images are in the form of photographs, videos, or combinations thereof. In some embodiments, the plurality of images are in the form of photographs. In some embodiments, the plurality of images are in the form of videos.

In some embodiments, the computing devices of the present disclosure further include programming instructions for capturing the plurality of images. In some embodiments, the methods of the present disclosure may also include a step of capturing the plurality of images.

The plurality of images may be captured sequentially during various periods of time. For instance, in some embodiments, at least 25 images may be captured per second. In some embodiments, at least 50 images may be captured per second. In some embodiments, at least 75 images may be captured per second. In some embodiments, at least 100 images may be captured per second. In some embodiments, at least 150 images may be captured per second. In some embodiments, at least 200 images may be captured per second.

In some embodiments, the plurality of images are captured through a camera. In some embodiments, the computing devices of the present disclosure also include a camera for capturing the plurality of images. In some embodiments, the camera includes a highspeed camera with at least 200 frames per second (FPS).

### Machine-Learning Algorithms

The methods and computing devices of the present disclosure may utilize various types of machine-learning algorithms. For instance, in some embodiments, the machine-learning algorithms may include, without limitation, nearest neighbor algorithms, naïve-Bayes algorithms, decision tree algorithms, linear regression algorithms, support vector machines, neural networks, convolutional neural networks, ensembles (e.g., random forests and gradient-boosted decision trees).

The machine-learning algorithms of the present disclosure include a DMA module. In some embodiments, the DMA module precisely identifies facial micro-movements in faces between two consecutive images. In particular, in some embodiments, a DMA module measures the patch-wise cosine similarity score between two corresponding patches from consecutive images. The higher similarity score, the lower chance of that there exists micro-movements inside the patch.

In some embodiments, the machine-learning algorithms of the present disclosure also include a patch of interest (POI) module. In some embodiments, the POI module identifies one or more facial regions containing a facial micro-expression pattern and guides the DMA module to identify a facial micro-movement within the identified facial regions. In some embodiments, the POI module is also trained to suppress sensitivities from the background. In some embodiments, the POI module is trained in an unsupervised manner without utilizing any facial labels, such as facial bounding boxes or landmarks. In some embodiments, the DMA module and the POI module are integrated into a neural network architecture.

In some embodiments, the machine-learning algorithms of the present disclosure are trained through a bidirectional transformers approach to identify at least one facial micro-expression pattern of a face of a subject in a self-supervised learning manner.

In some embodiments, the machine-learning algorithms of the present disclosure are designed in a self-supervised learning manner and trained in an end-to-end deep network. In some embodiments, the machine-learning algorithms of the present disclosure consistently achieve state-of-the-art (SOTA) results in various standard micro-expression benchmarks, including CASME II, CASME3, SAMM and SMIC. In some embodiments, the machine-learning algorithms of the present disclosure achieve high recognition accuracy on new unseen subjects of various gender, age, and ethnicity.

In some embodiments, machine-learning algorithms receive video as a input. In some embodiments, machine-learning algorithms receive two consecutive frame images of a video input. In some embodiments, machine-learning algorithms extract the features vectors of two consecutive frame images. In some embodiments, machine-learning algorithms execute the POI and DMA modules to get features of the micro-movements. In some embodiments, machine-learning algorithms reconstruct an original frame image from the features of the micro-movements.

### Facial Micro-Expression Patterns

The methods and computing devices of the present disclosure may be utilized to identify various facial micro-expression patterns. For instance, in some embodiments, the identified facial micro-expression patterns may include facial movements that last between 5 milliseconds and half a second. In some embodiments, the identified facial micro-expression patterns may represent involuntary occurrences. In some embodiments, the identification of facial micro-expression patterns also includes localization of the facial micro-expression patterns on the face. For instance, in some embodiments, the facial micro-expression patterns involve tiny movement in irises, eyebrow, mouth, or facial muscles.

In some embodiments, the machine learning algorithms of the present disclosure use a POI module to localize the facial region inside the image first. Thereafter, the machine learning algorithms use DMA to determine the probability that these micro-movements appear in each patch of image.

### Making a Determination

In some embodiments, the methods of the present disclosure also include a step of making a determination based on the identified facial micro-expression pattern. In some embodiments, the computing devices of the present disclosure also include programming instructions for making a determination based on the identified facial micro-expression pattern. In some embodiments, the determination includes, without limitation, lie detection, diagnosis of a disease or condition, or combinations thereof. In some embodiments, the determination includes lie detection.

In some embodiments, the determination includes diagnosis of a disease or condition. In some embodiments, the disease or condition includes autism. In some embodiments, the disease or condition includes autism in children as expressed by facial micro-expressions.

In some embodiments, the computing devices of the present disclosure further include programming instructions for recommending a treatment regimen for a disease or condition. In some embodiments, the methods of the present disclosure also include a step of implementing a treatment regimen for a disease or condition.

The methods and computing devices of the present disclosure may identify facial micro-expression patterns of various subjects. For instance, in some embodiments, the subject is a human being. In some embodiments, the subject may be susceptible of suffering from a disease or condition, such as autism.

### Computing Devices

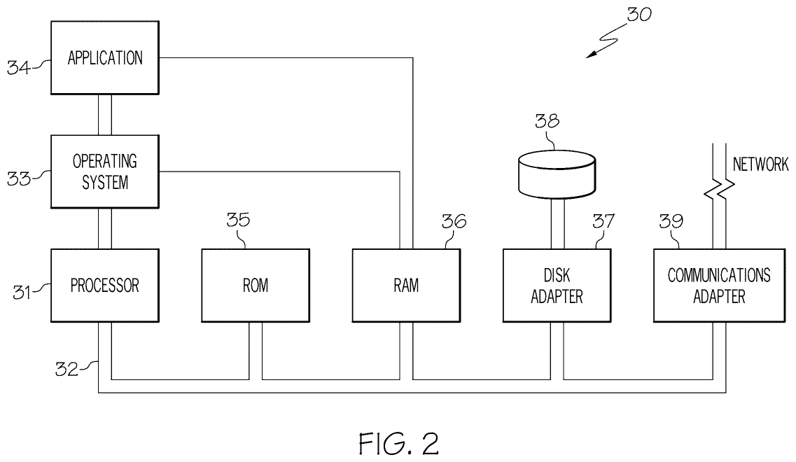

Embodiments of the present disclosure for identifying at least one facial micro-expression pattern of a face of a subject as discussed herein may be implemented using a system illustrated in FIG. 2. Referring now to FIG. 2, FIG. 2 illustrates an embodiment of the present disclosure of the hardware configuration of a system 30, which is representative of a hardware environment for practicing various embodiments of the present disclosure.

System 30 has a processor 31 connected to various other components by system bus 32. An operating system 33 runs on processor 31 and provides control and coordinates the functions of the various components of FIGS. 1 and 3-9. An application 34 in accordance with the principles of the present disclosure runs in conjunction with operating system 33 and provides calls to operating system 33, where the calls implement the various functions or services to be performed by application 34. Application 34 may include, for example, a program for identifying at least one facial micro-expression pattern of a face of a subject as discussed in the present disclosure, such as in connection with FIGS. 1 and 3-9.

Referring again to FIG. 2, read-only memory (“ROM”) 35 is connected to system bus 32 and includes a basic input/output system (“BIOS”) that controls certain basic functions of system 30. Random access memory (“RAM”) 36 and disk adapter 37 are also connected to system bus 32. It should be noted that software components including operating system 33 and application 34 may be loaded into RAM 36, which may be system's 30 main memory for execution. Disk adapter 37 may be an integrated drive electronics (“IDE”) adapter that communicates with a disk unit 38 (e.g., a disk drive). It is noted that the program for identifying at least one facial micro-expression pattern of a face of a subject, as discussed in the present disclosure, such as in connection with FIGS. 1 and 3-9, may reside in disk unit 38 or in application 34.

System 30 may further include a communications adapter 39 connected to system bus 32. Communications adapter 39 interconnects system bus 32 with an outside network (e.g., wide area network) to communicate with other devices.

Aspects of the present invention are described herein with reference to flowchart illustrations and/or block diagrams of methods, apparatus (systems), and systems according to embodiments of the invention. It will be understood that each block of the flowchart illustrations and/or block diagrams and combinations of blocks in the flowchart illustrations and/or block diagrams can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks. The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and systems according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Applications and Advantages

The goal of micro-expression spotting (MES) is to determine the specific instant during which a micro-expression occurs. Prior studies adopted a spatial-channel attention network to detect micro-expression action units. Other studies attempted to standardize with the SMIC-E database and an evaluation protocol. For instance, a study introduced a CNN-based approach with a (2+1)D convolutional network, a clip proposal, and a classifier.

The goal of micro-expression recognition (MER) tasks is to classify the facial micro-expressions in a video. Studies have presented a new way of learning facial graph representations, allowing these small movements to be seen.

In some embodiments, the DMA modules of the machine-learning algorithms of the present disclosure are advantageous over prior algorithms because they are capable of learning the facial micro-movements of subjects across frames. In some embodiments, the POI modules of the machine-learning algorithms of the present disclosure are advantageous because they are able to focus on the most salient parts of a facial micro-expression pattern (e.g., facial regions) and ignore the noisy sensitivities from the background.

As such, the methods and computing devices of the present disclosure can identify facial micro-expression patterns in various advantageous manners. Such advantages include high accuracy, speed, and flexibility for deployment.

Moreover, the methods and computing devices of the present disclosure can have various applications. Such applications include, without limitation, surveillance and monitoring; marketing and advertising; robotics and e-learning; healthcare; and medical emergencies. Furthermore, the methods and computing devices of the present disclosure can be utilized in various industries. Such industries include, without limitation, law enforcement; banking, financial services and insurance; healthcare and life sciences; information technology and telecommunication; retail and eCommerce; education; media and entertainment; and the automotive industry.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Micron-BERT: BERT-Based Facial Micro-Expression Recognition

Micro-expression recognition is one of the most challenging topics in affective computing. It aims to recognize tiny facial movements difficult for humans to perceive in a brief period (i.e., 0.25 to 0.5 seconds). Recent advances in pre-training deep Bidirectional Transformers (BERT) have significantly improved self-supervised learning tasks in computer vision. However, the standard BERT in vision problems is designed to learn only from full images or videos, and the architecture cannot accurately detect details of facial micro-expressions.

This Example presents Micron-BERT (μ-BERT), a novel approach to facial micro-expression recognition. The proposed method can automatically capture these movements in an unsupervised manner based on two key ideas. First, Applicant employs Diagonal Micro-Attention (DMA) to detect tiny differences between two frames. Second, Applicant introduces a new Patch of Interest (PoI) module to localize and highlight micro-expression interest regions and simultaneously reduce noisy backgrounds and distractions. By incorporating these components into an end-to-end deep network, the proposed μ-BERT significantly outperforms all previous work in various micro-expression tasks. μ-BERT can be trained on a large-scale unlabeled dataset, (i.e., up to 8 million images), and achieves high accuracy on new unseen facial micro-expression datasets. Empirical experiments show μ-BERT consistently outperforms state-of-the art performance on four micro-expression benchmarks, including SAMM, CASME II, SMIC, and CASME3, by significant margins.

The contributions of this Example include at the least following. (1) A novel Facial Micro-expression Recognition (MER) via Pre-training of Deep Bidirectional Transformers approach (Micron-BERT or μ-BERT) is presented to tackle the problem in a self-supervised learning manner. (2) The proposed method aims to identify and localize micro-movements in faces accurately. (3) As detecting the tiny moment changes in faces is an essential input to the MER module, a new Diagonal Micro Attention (DMA) mechanism is proposed to precisely identify small movements in faces between two consecutive video frames. (4) A new Patch of Interest (POI) module is introduced to efficiently spot facial regions containing the micro-expressions. Far apart from prior methods, it is trained in an unsupervised manner without using any facial labels, such as facial bounding boxes or landmarks. (5) The proposed μ-BERT framework is designed in a self-supervised learning manner and trained in an end to end deep network. Indeed, it consistently achieves State-of-the-Art (SOTA) results in various standard micro-expression benchmarks, including CASME II, CASME3, SAMM and SMIC. The framework also achieves high recognition accuracy on new unseen subjects of various gender, age, and ethnicity.

### Example 1.1. The Proposed μ-BERT Approach

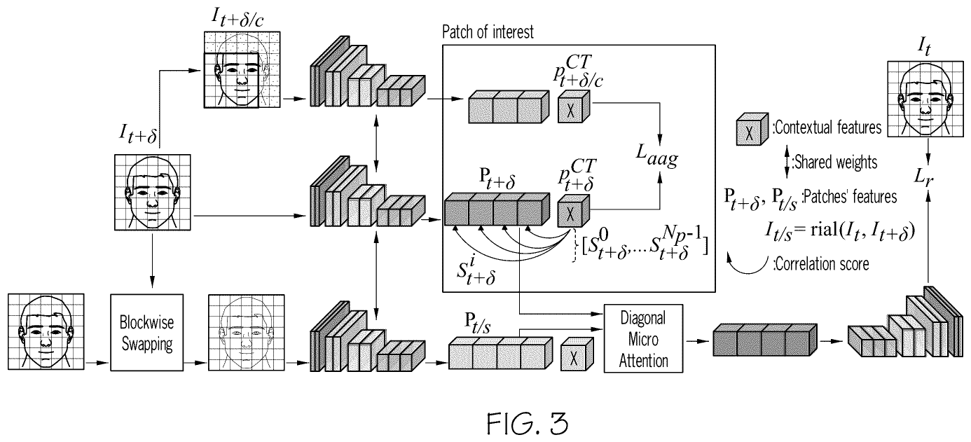

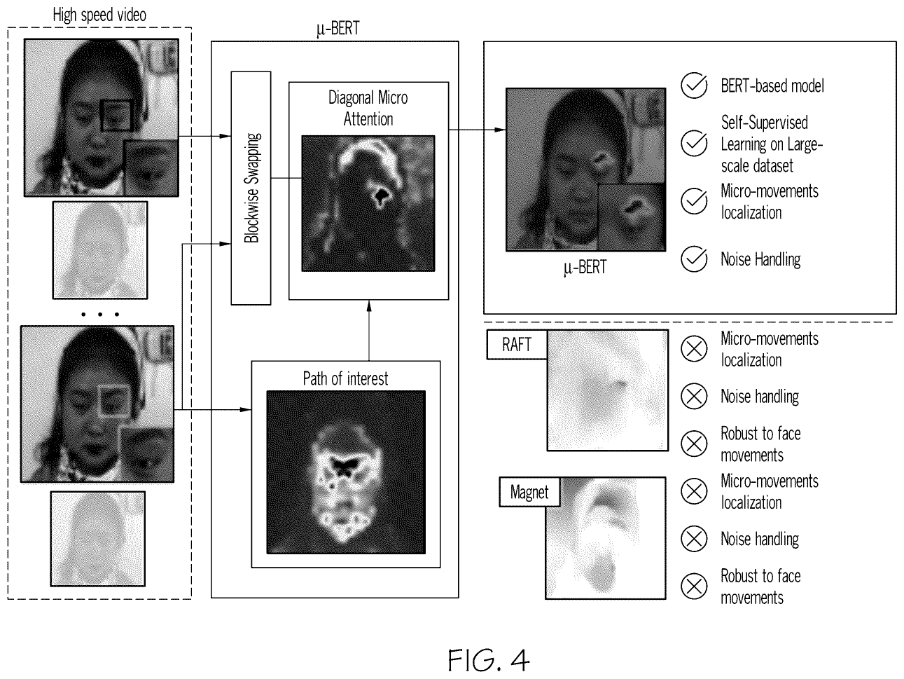

As illustrated in FIGS. 3 and 4, μ-BERT is designed to model micro-changes of facial texture across temporal dimensions, which is hard to observe by unaided human eyes via a reconstruction process. The proposed μ-BERT architecture, shown in FIG. 3, consists of five main blocks: a μ-Encoder, Patch of Interest (PoI), Blockwise Swapping, Diagonal Micro Attention (DMA), and a μ-Decoder. Given input images Iₜ and I_{t+δ}, the role of the μ-Encoder is to represent Iₜ and I_{t+δ} into latent vectors. Then, Patch of Interest (PoI) constrains μ-BERT to look into facial regions containing microexpressions rather than unrelated regions such as the background.

Blockwise Swapping and Diagonal Micro Attention (DMA) allow the model to focus on facial regions that primarily consist of micro differences between frames. Finally, μ-Decoder reconstructs the output signal back to the determined one. Compared to prior works, μ-BERT can adaptively focus on changes in facial regions while ignoring the ones in the background and effectively recognizes micro-expressions even when face movements occur. Moreover, μ-BERT can also alleviate the dependency on the accuracy of alignment approaches in pre-processing step.

### Example 1.2. Non-Overlapping Patches Representation

In μ-BERT, an input frame Iₜ∈R^{H×W×C} is divided into a set of several non-overlapping patches Pt as Equation (1).

$$\begin{matrix}{𝒫}_{t} = {\{ {p}_{t}^{i} \}}_{t = 0}^{{N}_{p} - 1} & \vert {𝒫}_{t} \vert\end{matrix} = HW / ( p {s}^{2} ) \qquad ( 1 )$$

In Equation 1, H, W, C are the height, width, and number of channels, respectively. Each patch pⁱₜ has a resolution of ps×ps. In Applicant's experiments, H=W=224, C=3, and ps=8.

### Example 1.3. μ-Encoder

Each patch pᵢ∈Pₜ is linearly projected into a latent vector of dimension d denoted as zⁱₜ∈R^{1×d}, with additive fixed positional encoding. Then, an image Iₜ can be represented as in Equation (2).

$$Z \text{?} = concat [ {z}_{t}^{0} , {z}_{1}^{t} , … {z}_{t}^{{N}_{p} - 1} ] ∈ {ℝ}^{{N}_{p} \times d} \qquad ( 2 )$$

$$z \text{?} = α ( {p}_{t}^{1} ) + e ( i )$$

$$\text{?} \text{indicates text missing or illegible when filed}$$

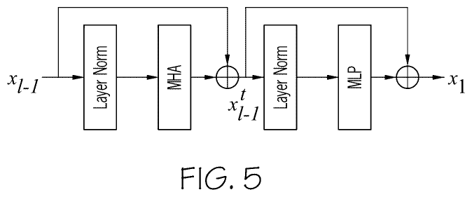

In Equation 2, where α and e are the projection embedding network and positional embedding, respectively. Let μ-Encoder, denoted as E, be a stack of continuous blocks. Each block consists of alternating layers of Multi Head Attention (MHA) and Multi-Layer Perceptron (MLP), as illustrated in FIG. 5. The Layer Norm (LN) is employed to the input signal before feeding to MHA and MLP layers, as in Equation (3).

$${x}_{l}^{′} = {x}_{l - 1} + MHA ( LN ( {x}_{i - 1} ) ) \qquad ( 3 )$$

$$x \text{?} = x \text{?} + MLP ( LN ( {x}_{l}^{′} ) )$$

$${x}_{0} = {Z}_{t} , 1 \leq l \leq L \text{?}$$

$$\text{?} \text{indicates text missing or illegible when filed}$$

In Equation 3, Lₑ is the number of blocks in E. Given Zₜ, the output latent vector Pₜ is represented as in Equation (4).

$$\begin{matrix}{P}_{t} = ℰ ( {Z}_{t} ) & {P}_{t} ∈ {ℝ}^{{N}_{p} \times d}\end{matrix} \qquad ( 4 )$$

### Example 1.4. μ-Decoder

The proposed auto-encoder is designed symmetrically. It means that the decoder part denoted as D, has a similar architecture to the encoder E. Given a latent vector Pₜ, the decoded signal Qₜ is represented as in Equation (5).

$$\begin{matrix}{Q}_{t} = 𝒟 ( {P}_{t} ) & {Q}_{t} ∈ {ℝ}^{{N}_{p} \times d}\end{matrix} \qquad ( 5 )$$

Applicant added one more Linear layer to interpolate Qt to an intermediate signal yₜ before reshaping it into the image size.

$$\begin{matrix}{Q}_{t} ∈ {ℝ}^{{N}_{p} \times d} {⟶}^{linear} {y}_{t} ∈ {ℝ}^{{N}_{p} \times p s \times p s \times C} \\ {y}_{t} ∈ {ℝ}^{{N}_{p} \times p s \times p s \times C} {⟶}^{reshape} {y}_{t}^{′} ∈ {ℝ}^{H \times W \times C}\end{matrix} \qquad ( 6 )$$

### Example 1.5. Blockwise Swapping

Given two frames Iₜ and I_{t+δ}, Applicant realize the fact that:

$${lim}_{δ ⟶ 0} 𝓈 ( {p}_{t}^{i} , {p}_{t + δ}^{i} ) = 1 \qquad ( 7 )$$

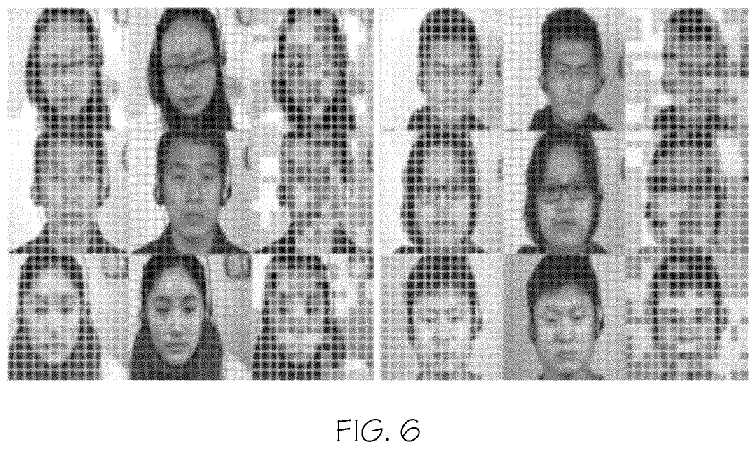

In Equation 7, pⁱₜ is the i^{th}-patch at frame t. s denotes a function to measure the similarity between pⁱₜ and pⁱ_{t+δ}, where a higher score indicates higher similarity and 0≤s(pⁱₜ, pⁱ_{t+δ})≤1. Given a patch correlation as in Equation (7), Applicant proposes a Blockwise Swapping mechanism to (1) firstly randomly swap two corresponding blocks pⁱₜ and pⁱ_{t+δ} between two frames to create a swapped image I_{t/s}, and then (2) enforce the model to spot these changes and reconstruct Iₜ from I_{t/s}. By doing so, the model is further strengthened in recognizing and restoring the swapped patches. As a result, the learned model can be enhanced by the capability to notice small differences between frames. Moreover, as shown in Equation (7), shorter time δ causing larger similarity between It from I_{t/s} can further help to enhance the robustness on spotting these differences. The detail of this strategy is described in Table 1 (Algorithm 1) and FIG. 6.

TABLE 1
Algorithm 1. Blockwise swapping.

```
Input: [symbol]   ₜ, [symbol]   ₜ₊₅ image patches (Nₚ = h × w); rₛ: swapping
ratio (default: 0.5) [symbol]  min_bs: minimum block size (default: 16) [symbol]
min_ar: minimum aspect ratio (default: 0.3)
Output: Swapped image patches [symbol] [symbol]     / [symbol] [symbol] [symbol]
/ [symbol]  ← [symbol] [symbol]      Nₚ ← | [symbol]   ₜ|

[symbol]
← 0
while c ≤ r [symbol]  × Nₚ do
  bs ← rnd(min_b [symbol] , r [symbol]  × Nₚ − c)
  ar ← rnd(min_ar [symbol]  1/min_ar)
  m, n ← √bs · ar [symbol]  √bs/ar
  p, q ← rnd(0, h − m), rnd(0, w − n)
  ∀ [symbol]  ∈ [p, p + m), j ∈ [q, q + n) :
    k ← i × w + j [symbol] [symbol]
    (k) ← [symbol]   ₜ₊ [symbol] (k)
  c ← c + m × n
end while
return [symbol] [symbol] [symbol]
indicates data missing or illegible when filed
```

### Example 1.6. Diagonal Micro Attention (DMA)

As a result of Blockwise Swapping, the image patches P_{t/s} from I_{t/s} consists of two types, i.e. p^{j}_{t/s} from Pₜ of Iₜ and pⁱ_{t/s} from P_{t+δ} of I_{t+δ}. Then, the next stage is to learn how to reconstruct Pₜ from P_{t/s}. Since pⁱ_{t/s} includes all changes between Iₜ and I_{t/s}, more emphasis is placed on pⁱ_{t/s} during reconstruction process. Theoretically, the ground truth of the index of pⁱ_{t/s} in P_{t/s} can be utilized to enforce the model focusing on these swapped patches. However, adopting this information may reduce the learning capability to spot these microchanges. Therefore, a novel attention mechanism named Diagonal Micro-Attention (DMA) is presented to enforce the network automatically focusing on swapped patches pⁱ_{t/s} and equip it with the ability to precisely spot and identify all changes between images. Notice that these changes may include patches in the background. The following section introduces a solution to constrain the learned network focusing on only meaningful facial regions.

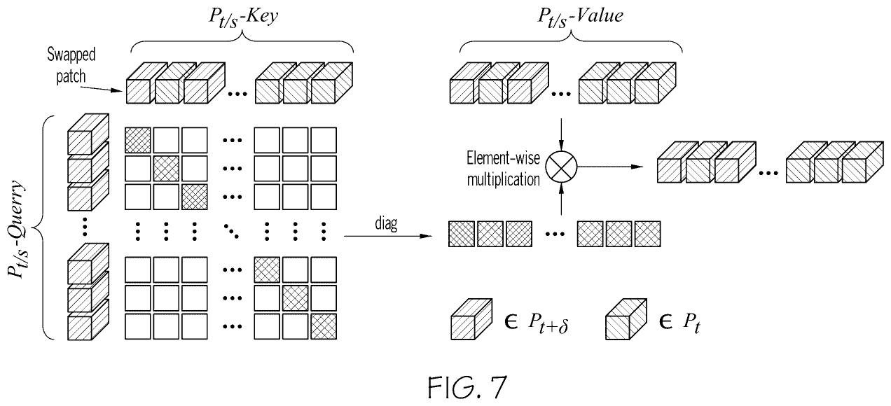

The details of DMA are presented in FIG. 7. Formally, Applicant constructs an attention map A\hat{ } between P_{t+δ} and P_{t/s} where the diag(A\hat{ }) illustrates correlations between two corresponding patches pⁱ_{t+δ} and pⁱ_{t/s}. From the observation that A\hat{ }(i, i)>A\hat{ }(j, j) for all pⁱ_{t/s}∈P_{t+δ} and pⁱ_{t/s}∈Pₜ, diag(A\hat{ }) can be effectively adopted as weights indicating important features. Full operations of DMA are presented in Equations (8) and (9).

$$\hat{A} = softmax ( Q ( P \text{?} ) ⊗ {K ( P \text{?} )}^{T} ) , {\sum }_{j = 0}^{{N}_{p}} \text{?} ( t , j ) = 1 \qquad ( 8 )$$

$${P}_{dma} = diag ( \hat{A} ) \times V ( P \text{?} ) \qquad ( 9 )$$

$$\text{?} \text{indicates text missing or illegible when filed}$$

In Equations 8 and 9, × denotes the Element-wise multiplication operator.

As illustrated in FIG. 7, two consecutive images are firstly passed into a Blockwise Swapping module to randomly swap two corresponding patches between two images and create a new image that contain micro changes. Additionally, an image is randomly cropped. After that, these images continue to be passed into an image encoder to extract the visual features vectors. These features vectors are now passed into POI and DMA modules, correspondingly to construct the micro-movement features vector. This feature vector is finally passed into an image decoder to reconstruct to the original frames.

### Example 1.7. Patch of Interest (POI)

In Example 1.6, Diagonal Micro-Attention has been introduced to weigh the importance of swapped patches automatically. These swapped patches are randomly produced via Blockwise Swapping, as in Algorithm 1 (Table 1). In theory, the ideal case is when all swapped patches are located within the facial region only so that the deep network can learn the micro-movements from the facial parts solely and not be distracted by the background.

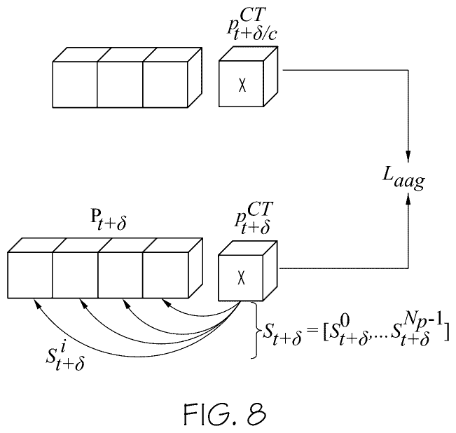

In practice, however, Applicant can only identify which parts are selected in the Blockwise Swapping algorithm if the facial regions are available. Thus, the Patch of Interest (POI) is introduced to automatically explore the salient regions and ignore the background patches in an image. Apart from prior methods, the proposed POI leverages the characteristic of self-attention and can be achieved through self-learning without facial labels, such as facial bounding boxes or segmentation masks. The idea of the POI module is illustrated in FIG. 8. Due to POI, a capability of automatically focusing on facial regions is further equipped to the learned model, making it more robust against facial movements.

The POI relies on the contextual agreement between the frame I_{t+δ} and Crop(I_{t+δ}). Motivated by the BERT framework, Applicant add a Contextual Token z^{CT} to the beginning of the sequence of patches, as in Equation (2), to learn the contextual information in the image. The deeper this token passes through the Transformer blocks, the more information is accumulated from zⁱₜ∈Pₜ. As a result, z^{CT} becomes a placeholder to store the information extracted from other patches in the sequence and present the contextual information of the image. Let p^{CT}_{t+δ} and p^{CT}_{t+δ/c} be the contextual features of frame I_{t+δ} and its cropped version Crop(I_{t+δ}), respectively. The agreement loss is then defined as in Equation (10).

$${ℒ}_{agg} = H ( {p}_{t + δ}^{CT} , {p}_{t + δ / c}^{CT} ) \qquad ( 10 )$$

In Equation 10, H is the function that enforces p^{CT}_{t+δ} to be similar to p^{CT}_{t+δ/crop} so that the model can discover the salient patches. The POI can be extracted from the attention map A at the last attention layer of encoder E. In particular, Applicant measures:

$$𝒮 \text{?} = A [ 0 , : ] = [ {𝓈}^{0} \text{?} , {𝓈}^{1} \text{?} , … {𝓈}^{{N}_{p} - 1} \text{?} ] \qquad ( 11 )$$

$$\text{?} \text{indicates text missing or illegible when filed}$$

In Equation 11, Σ^{N}^{ₚ}⁻¹ᵢ₌₀sⁱ_{t+δ}=1. The higher the score sⁱ_{t+δ}, the richer the patch contains contextual information. Now, Equation (9) can be reformulated as in Equation (12).

$$\begin{matrix}W = diag ( \hat{A} ) \times {𝒮}_{t + δ} \\ {P}_{dma} = W \times V ( P \text{?} )\end{matrix} \qquad ( 12 )$$

$$\text{?} \text{indicates text missing or illegible when filed}$$

### Example 1.8. Loss Functions

The proposed μ-BERT deep network is optimized using the proposed loss function as in Equation (13).

$$ℒ = γ \times {ℒ}_{r} + β \times {ℒ}_{agg} \qquad ( 13 )$$

In Equation 13, γ and β are the weights for each loss.

Reconstruction Loss. The output of the decoder y′ₜ is reconstructed to the original image Iₜ using the Mean Square Error (MSE) function.

$${ℒ}_{r} = MSE ( {y}_{t}^{′} , {I}_{t} ) \qquad ( 14 )$$

Contextual Agreement Loss. MSE is also used to enforce the similarity of contextual features of I_{t+δ/crop} and I_{t+δ}.

$${ℒ}_{agg} = MSE ( {p}_{t + δ}^{CT} , {p}_{t + δ / crop}^{CT} ) \qquad ( 15 )$$

### Example 1.9. Datasets and Protocols

CASME II. With a 200 fps sampling rate and a facial resolution of 280×340, CASME II provides 247 microexpression samples from 26 subjects of the same ethnicity. Labels include apex frames, action units, and emotions.

SAMM. Also, using a 200 fps frame rate and a facial resolution of 400×400, SAMM consists of 159 samples from 32 participants and 13 ethnicities. The samples all have emotions, apex frames, and action unit labels.

SMIC. SIMC is made up of 164 samples. Lacking apex frame and action unit labels, the samples span 16 participants of 3 ethnicities. The recordings are taken with a resolution of 640×480 at 100 fps.

CASME3. Officially known as CAS(ME)3 provides 1,109 labeled micro-expressions and 3,490 labeled macroexpressions. This dataset has roughly 80 hours of footage with a resolution of 1280×720.

### Example 1.10. Micro-Expression Self-Training

Applicant uses an all raw frames from CASME3 for self-training except frames of test set. It is important to note that we do not use labels or meta information such as onset, offset, and apex index frames nor labeled emotions. In total, Applicant constructed an un-labelled dataset of 8M frames. The images are resized to 224×224. Then, each image is divided into patches of 8×8, yielding Np=784 patches. The temporal index δ is selected randomly between a lower bound of 5 and an upper bound of 11, experimentally.

The swapping ratio rs is selected as 50% of the number of patches being swapped from It+δ to It. Each patch is projected to a latent space of d=512 dimensions before being fed into the encoder and decoder. For the encoder and decoder, Applicant keeps the same d for all vectors and similar configurations, i.e., Le=Ld=4.

μ-BERT is implemented easily in Pytorch framework and trained by 32×A100 GPUS (40 G each). The learning rate is set to 0.0001 initially and then reduced to zero gradually under ConsineLinear policy. The batch size is set to 64/GPU. The model is optimized for 100 epochs. The training is completed within three days.

### Example 1.11. Micro-Expression Recognition

Applicant leverages the pretrained μ-BERT as an initial weight and take the encoder E and DMA module of μ-BERT as the MER backbone. The input of MER is the onset and apex frames which correspond to Iₜ and I_{t+δ} respectively. In Equation (8), Pdma are the features representing the micro changes and movements between onset and apex frames. They can be effectively adopted for recognizing microexpressions.

Applicant adopt the standard metrics and protocols of MER2019 challenge with the unweighted F1 score

$$UF 1 = \frac{1}{C} {\sum }_{i = 0}^{C - 1} \frac{\begin{matrix}\begin{matrix}- \\ \end{matrix} & 2 \times {TP}_{i}\end{matrix}}{{TP}_{i} + {FP}_{i} + {FN}_{i}} and UAR = \frac{1}{C} {\sum }_{i = 0}^{C - 1} \frac{{TP}_{i}}{{N}_{i}} ,$$

where C is the number of MEs, Ni is the total number of i^{th} ME in the dataset. Leave-one-out cross-validation (LOOCV) scheme is used for evaluation.

### Example 1.12. Results

Applicant's proposed μ-BERT shows a significant improvement over prior methods and baselines, as shown in Table 2 on the CASME3. Tested using 3, 4, and 7 emotion classes, μ-BERT achieves double-digit gains over the compared methods in each category. In the case of 3 emotion classes, μ-BERT achieved a 56.04% UF1 score and 61.25% UAR, compared to RCN-A's 39.28% UF1 and 38.93% UAR. For 4 emotion classes, μ-BERT outperforms Baseline (+Depth) 47.18% to 30.01% for UF1 and 49.13% to 29.82% for UAR. Large gains over Baseline (+Depth) are seen in the case of 7 emotion classes, where μ-BERT attains UF1 and UAR scores of 32.64% and 32.54% respectively, compared to 17.73% and 18.29% for the baseline.

Table 3 details results for CASMEII. μ-BERT shows improvements over all other methods. For three categories, it achieves a UF1 of 90.34% and UAR of 89.14%, representing 3.37% and 0.86% increases over the prior leading method, respectively. Similar improvement is seen in five categories: a 4.83% over TSCNN in terms of UF1 and a 0.89% increase over SMA-STN for UAR. Similarly, μ-BERT performs competitively with other methods on the SAMM as seen in Table 4. Using 5 emotion classes, μ-BERT outperforms MinMaNet by a large margin in terms of UF1 (83.86% vs 76.40%) and UAR (84.75% vs 76.70%), respectively. The performance of μ-BERT on SMIC is compared against several others in Table 5. μ-BERT outperforms others with a 7.5% increase in UF1 to 85.5% and a 3.97% boost in UAR to 83.84%.

On the composite dataset, μ-BERT again outperforms other methods (Table 6). Attaining a UF1 score of 89.03% and UAR of 88.42%, μ-BERT realizes 0.73%, and 0.82% gains over previous best MiMaNet, respectively. Table 7 shows the impact of DMA and POI on CASME3. Applicant's method gives more modest gains of approximately 2% in both metrics. A greater improvement is seen with DMA, where UF1 and UAR increase by another 2-4%. Significant improvement from μ-BERT is seen when adopting both modules, with a UF1 of 32.64% and UAR of 32.54%, representing roughly 10% gains over previous methods.

### Example 1.13. How μ-BERT Perceives Micro-Movements

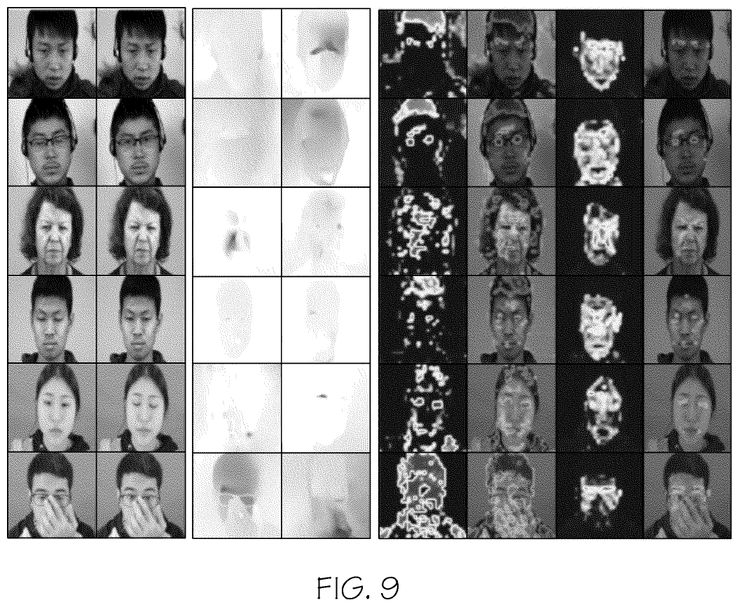

To understand the micro-movements between two frames, the onset and apex frames are inputs for μ-BERT. These frames represent the moments that the microexpression starts and is observed. Applicant measures diag(A\hat{ }) (Example 1.6) and S_{t+δ} (Equation (11)) values to identify which regions contain small movements between two frames. Comparisons of μ-BERT with RAFT, i.e., optical flow-based method and MagNet are also conducted as in FIG. 9. The third and fourth columns in FIG. 9 show the results of RAFT, and MagNet on spotting the micro-movements, respectively. While RAFT is an optical flow-based method, MagNet amplifies small differences between the two frames. These methods are sensitive to the environment (e.g., lighting, illuminations). Thus, noises in the background still exist in their outputs. In addition, neither RAFT nor MagNet understand semantic information in the frame and distinguish changes inside facial or background regions.

Meanwhile, μ-BERT shows its advantages in perceiving micro-movements via distinguishing the facial regions and spotting the micro-expressions. In particular, the attention map in the fifth column, in FIG. 9 illustrates the micro-differences between onset and apex frames. The higher contrast represents the higher chance of small movements in these regions. With the POI module, μ-BERT can automatically figure out the informative patches and ignore the background ones. Then, with DMA module, μ-BERT, can detect and localize which corresponding patches/regions contain tiny movements. As shown in the seventh column, attention maps represent the most salient regions in the image. By empowering DMA and POI, μ-BERT effectively identifies micro-movements within facial regions, as demonstrated in the last column.

TABLE 2
MER on the CASME3 dataset.

| Method | # Classes | UFI (%) | UAR(%) |
|---|---|---|---|
| FR | 3 | 34.93 | 34.13 |
| STSTNet \| | 3 | 37.95 | 37.92 |
| RCN-A | 3 | 39.28 | 38.93 |
| μ-BERT | 3 | 56.04 | 61.25 |
| Baseline | 4 | 29.15 | 29.10 |
| Baseline (+Depth) | 4 | 30.01 | 29.82 |
| μ-BERT | 4 | 47.18 | 49.13 |
| Baseline | 7 | 17.59 | 18.01 |
| Baseline(+Depth) | 7 | 17.73 | 18.29 |
| μ-BERT | 7 | 32.64 | 32.54 |

TABLE 3
MER on CASME II dataset.

| Method | # Classes | UFI (%) | UAR (%) |
|---|---|---|---|
| LR-GACNN | 5 | 70.90 | 81.30 |
| AMAN | 5 | 71.00 | 75.40 |
| Graph-TCN | 5 | 72.46 | 73.98 |
| DSTAN | 5 | 73.00 | 75.00 |
| GEME | 5 | 73.54 | 75.20 |
| MiMaNet | 5 | 75.90 | 79.90 |
| SMA-STN | 5 | 79.46 | 82.59 |
| TSCNN | 5 | 80.70 | 80.97 |
| μ-BERT | 5 | 85.53 | 83.48 |
| STSTNet | 3 | 83.82 | 86.86 |
| OFF-ApexNet | 3 | 86.97 | 88.28 |
| MAE | 3 | 88.03 | 87.28 |
| μ-BERT | 3 | 90.34 | 89.14 |

TABLE 4
MER on SAMM dataset.

| Method | # Classes | UFI (%) | UAR (%) |
|---|---|---|---|
| AMAN | 5 | 67.00 | 68.85 |
| SMA-STN | 5 | 70.33 | 77.20 |
| GRAPH-AU | 5 | 70.45 | 74.26 |
| MTMNet | 5 | 73.60 | 74.10 |
| MiMaNet | 5 | 76.40 | 76.70 |
| MAE | 5 | 80.40 | 88.98 |
| μ-BERT | 5 | 83.86 | 84.75 |

TABLE 5
MER on SMIC dataset.

| Method | # Classes | UFI (%) | UAR (%) |
|---|---|---|---|
| DIKD | 3 | 71.00 | 76.06 |
| TSCNN | 3 | 72.36 | 72.74 |
| MTMNet | 3 | 74.40 | 76.00 |
| AMAN | 3 | 77.00 | 79.87 |
| MiMaNet | 3 | 77.80 | 78.60 |
| DSTAN | 3 | 78.00 | 77.00 |
| MAE | 3 | 81.86 | 80.82 |
| μ-BERT | 3 | 85.50 | 83.84 |

### Example 1.14. Ablation Studies

This section compares μ-BERT against other self-supervised learning (SSL) methods on the MER task. CASME3 is used for experiments since it has many un-labelled images to demonstrate the power of SSL methods.

Applicant also analyzes the essential contributions of Diagonal Micro-Attention (DMA) and Patch of Interest (POI) modules. Finally, Applicant illustrates the robustness of μ-BERT pretrained on CASME3 on unseen datasets and domains.

Comparisons with self-supervised learning methods. Applicant utilized the encoder and decoder parts of μ-BERT (without DMA and POI) to train previous SSL methods (MoCo V3, BEIT, and MAE) and then continue learning the MER task on the large-scale database CASME3. Overall results are shown in Table 6. It is expected that ViT-S achieves the lowest performance for UF1 and UAR as ImageNet and Micro-Expression are two different domains. Three self-supervised methods (MoCo V3, BEIT, and MAE) got better results when they were pretrained on CASME before fine-tuning to the recognition task. Compared to ViT-S, these SSL methods gain remarkable performance. Especially, MAE achieves 3.5% and 2% up on UF1 and UAR compared to ViT-S, respectively.

The role of Blockwise Swapping. Applicant's basic setup of μ-BERT (denoted as MB1) is employed to train in an SSL manner. It is noted that only Blockwise Swapping is involved, and it does not contain either DMA or POI. Compared to MAE, MB1 outperforms MAE by 2% in both UF1 and UAR, approximately. The reasons are: (1) Blockwise Swapping enforces the model to learn local context features inside an image (i.e., Iₜ), and (2) It helps the network to figure out micro-disparities between two frames Iₜ and I_{t+δ}.

The role of DMA. This module is the guide to tell the network where to look and which patches to focus. By doing so, the μ-BERT gets more robust knowledge of micro-movements between two frames. For this reason, the network (denoted as MB2) achieves 2% on UF1 and a significant 4% gain on UAR compared to MB1.

The role of POI. Since MB1 are sensitive to background noise, the micro-disparities features Pdma might contain unwanted features coming from the background. The POI is designed as a filter that only lets the typical interesting patches belonging to the subject go through and preserves the micro-movement features only. The improvements of up to 6% compared to MB2 demonstrate the important role of POI in μ-BERT for micro-expression tasks. Qualitative results can further emphasize the advantages of POI in assisting the network to be robust against facial movements.

In sum, unlike a few concurrent research on micro-expression, Applicant move forward and study how to explore BERT pretraining for this problem. In μ-BERT, Applicant presented a novel Diagonal Micro Attention (DMA) to learn the micro-movements of the subject across frames. The Patch of Interest (POI) module is proposed to guide the network, focusing on the most salient parts, i.e., facial regions, and ignoring the noisy sensitivities from the background.

Empowered by the simple design of μ-BERT, SOTA performance on micro-expression recognition tasks is achieved in four benchmark datasets. Our perspective will inspire more future study efforts in this direction.

TABLE 6
MER on the Composite dataset (MECG2019).

| Method | # Classes | UFI (%) | UAR(%) |
|---|---|---|---|
| Dual-Inception | 3 | 73.22 | 72.78 |
| FR | 3 | 78.38 | 78.32 |
| NMER | 3 | 78.85 | 78.24 |
| GRAPH-AU | 3 | 79.14 | 79.33 |
| ICE-GAN | 3 | 84.50 | 84.10 |
| BDCNN | 3 | 85.09 | 85.00 |
| moment | 3 | 86.40 | 85.70 |
| MiMaNet | 3 | 88.30 | 87.60 |
| MAE | 3 | 88.50 | 87.40 |
| μ-BERT | 3 | 89.03 | 88.42 |

TABLE 7
MER performance on CASME3 by different self-supervised
methods and various settings of μ-BERT

| Method | Pre-train | DMA | POI | UFI | UAR |
|---|---|---|---|---|---|
| ViT-S | ImageNet | X | X | 20.34 | 18.76 |
| MoCo V3 - R50 | CASME3 | X | X | 19.12 | 17.36 |
| MoCo V3 - R101 | CASME3 | X | X | 20.14 | 18.52 |
| MoCo V3 | CASME3 | X | X | 22.13 | 19.34 |
| BEIT | CASME3 | X | X | 23.54 | 19.89 |
| MAE | CASME3 | X | X | 23.86 | 20.87 |
| μ-BERT (MB1) | CASME3 | X | X | 25.27 | 22.96 |
| μ-BERT (MB2) | CASME3 | ✓ | X | 27.35 | 26.18 |
| μ-BERT (MB3) | CASME3 | ✓ | ✓ | 32.64 | 32.54 |

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A computer-implemented method of identifying at least one facial micro-expression pattern of a face of a subject, said method comprising:
receiving a plurality of images of the face of the subject, wherein the plurality of images represent consecutive images of the face of the subject taken sequentially during a period of time;
feeding the plurality of images into a machine-learning algorithm, wherein the machine-learning algorithm comprises:
a diagonal micro attention (DMA) module, wherein the DMA module identifies at least one facial micro-movement between the plurality of images and correlates the facial micro-movement to at least one facial micro-expression pattern; and
outputting the at least one facial micro-expression pattern.

2. The method of claim 1, wherein the plurality of images are in the form of photographs, videos, or combinations thereof.

3. The method of claim 1, wherein the plurality of images are in the form of photographs.

4. The method of claim 1, further comprising a step of capturing the plurality of images.

5. The method of claim 4, wherein the plurality of images are captured through a camera.

6. The method of claim 5, wherein the camera comprises a highspeed camera comprising at least 200 frames per second (FPS)

7. The method of claim 1, wherein the machine-learning algorithm further comprises a patch of interest (POI) module, wherein the POI module identifies on one or more facial regions containing the at least one facial micro-expression pattern and guides the DMA module to identify the at least one facial micro-movement within the one or more identified facial regions.

8. The method of claim 7, wherein the POI module is also trained to suppress sensitivities from the background.

9. The method of claim 7, wherein the POI module is trained in an unsupervised manner without utilizing any facial labels.

10. The method of claim 7, wherein the DMA module and the POI module are integrated into a neural network architecture.

11. The method of claim 1, further comprising a step of making a determination based on the identified facial micro-expression pattern.

12. The method of claim 11, wherein the determination is selected from the group consisting of lie detection, diagnosis of a disease or condition, or combinations thereof.

13. The method of claim 11, wherein the determination comprises lie detection.

14. The method of claim 11, wherein the determination comprises diagnosis of a disease or condition.

15. The method of claim 14, wherein the disease or condition comprises autism.

16. The method of claim 14, further comprising a step of implementing a treatment regimen for the disease or condition.

17. The method of claim 1, wherein the subject is a human being.

18. A computing device for identifying at least one facial micro-expression pattern of a face of a subject, wherein the computing device comprises one or more computer readable storage mediums having a program code embodied therewith, wherein the program code comprises programming instructions for:
receiving a plurality of images of the face of the subject, wherein the plurality of images represent consecutive images of the face of the subject taken sequentially during a period of time;
feeding the plurality of images into a machine-learning algorithm, wherein the machine-learning algorithm comprises:
a diagonal micro attention (DMA) module, wherein the DMA module identifies at least one facial micro-movement between the plurality of images and correlates the facial micro-movement to at least one facial micro-expression pattern; and
outputting the at least one facial micro-expression pattern of the face of the subject.

19. The computing device of claim 18, wherein the computing device further comprises programming instructions for capturing the plurality of images.

20. The computing device of claim 18, wherein the computing device further comprises a camera for capturing the plurality of images.

21. The computing device of claim 20, wherein the camera comprises a highspeed camera comprising at least 200 frames per second (FPS)

22. The computing device of claim 18, wherein the machine-learning algorithm further comprises a patch of interest (POI) module, wherein the POI module identifies on one or more facial regions containing the at least one facial micro-expression pattern and guides the DMA module to identify the at least one facial micro-movement within the one or more identified facial regions.

23. The computing device of claim 22, wherein the POI module is also trained to suppress sensitivities from the background.

24. The computing device of claim 22, wherein the POI module is trained in an unsupervised manner without utilizing any facial labels.

25. The computing device of claim 22, wherein the DMA module and the POI module are integrated into a neural network architecture.

26. The computing device of claim 18, wherein the computing device further comprises programming instructions for making a determination based on the identified facial micro-expression pattern.

27. The computing device of claim 26, wherein the determination is selected from the group consisting of lie detection, diagnosis of a disease or condition, or combinations thereof.

28. The computing device of claim 26, wherein the determination comprises lie detection.

29. The computing device of claim 26, wherein the determination comprises diagnosis of a disease or condition.

30. The computing device of claim 29, wherein the disease or condition comprises autism.

31. The computing device of claim 29, wherein the computing device further comprises programming instructions for recommending a treatment regimen for the disease or condition.

32. The computing device of claim 18, wherein the computing device further comprises a display for displaying the at least one facial micro-expression pattern of the face of the subject.
